(19) United States
(12) Patent Application Publication
(10) Pub. No.: US 2013/0286072 A1
(43) Pub. Date: Oct. 31, 2013

(54) CORRECTING WEB SKEW IN A PRINTING SYSTEM

(71) Applicants: Randy E. Armbruster, Rochester, NY (US); Christopher M. Muir, Rochester, NY (US); Brad Smith, Xenia, OH (US); Thomas Niertit, Webster, NY (US); Bradley C. DeCook, Rochester, NY (US)

(72) Inventors: Randy E. Armbruster, Rochester, NY (US); Christopher M. Muir, Rochester, NY (US); Brad Smith, Xenia, OH (US); Thomas Niertit, Webster, NY (US); Bradley C. DeCook, Rochester, NY (US)

(21) Appl. No.: 13/671,880

(22) Filed: Nov. 8, 2012

Related U.S. Application Data
(60) Provisional application No. 61/640,151, filed on Apr. 30, 2012.

(51) Int. Cl. B41J 29/38

(52) U.S. Cl. 347/14

(57) ABSTRACT

A printing system includes multiple lineheads that each jet ink onto a print media while the print media is transported through the printing system. Imaging devices are positioned to capture one or more images of each side of the print media. A method for correcting for web skew and front-to-back registration includes determining a skew positional error for each color plane in a printing module and determining one or more skew positional correction values based on the skew positional error. A registration positional error can be determined and one or more registration positional correction values can be determined based on the registration positional error. A setting or operation of at least one printing system component is automatically adjusted based on at least one registration positional correction value or at least one skew positional correction value.

### CROSS-REFERENCE TO RELATED APPLICATIONS)

This application claims the benefit of U.S. Provisional Application 61/640,151 filed on Apr. 30, 2012.

### TECHNICAL FIELD

The present invention generally relates to printing systems and more particularly to a method for correcting web skew and front-to-back registration in a printing system.

### BACKGROUND

Continuous web printing allows economical, high-speed, high-volume print reproduction. In this type of printing, a continuous web, such as print media (e.g., paper) or a support mechanism in which the print media is disposed over, is fed past one or more printing subsystems or modules that form images by applying one or more colorants onto the surface of the print media. Various components within a printing system are used to create tension in the web so that the web does not shift in the in-track (the direction of movement) and cross-track directions as the web moves through the printing system. The tension is also used to inhibit fluttering (up or down motion) as the web travels through the printing system.

FIG. 1 illustrates a desired position for a web of print media in a printing system. The print media 100 is positioned in a cross track direction so as to maintain center justification of the print media 100 within a media operation zone 102. Typically, the center line 104 of the print media is maintained within acceptable tolerances relative to a device that is performing an operation on the print media while the print media is traveling through (located in) the media operation zone 102. The device that is performing an operation on the print media can be a linehead 106 that jets ink onto the print media or a dryer that dries the ink.

FIG. 2 depicts web skew in a printing system. The print media 100 is not positioned in a cross-track direction so as to maintain center justification of the print media 100 within the media operation zone 102. Instead, the print media 100 is skewed in the cross-track direction by a certain amount 200 such that the centerline of the print media is located at 202. Web skew can cause the color planes that are printed on the print media to be misaligned with respect to each other.

Another issue that adversely affects image quality is front-to-back mis-registration, where a front-side image 300 on one side of the print media 100 is misaligned in the cross-track direction with respect to a back-side image 302 on the other side of the print media. FIG. 3 illustrates a top view of front-to-back misalignment in the cross-track direction in a printing system. The printed content on one side of the print media 100 is shifted in the cross-track direction by a certain amount 304 with respect to the printed content on the other side of the print media 100.

The changes to web skew and front-to-back registration can be caused by one or more factors, including non-linear accuracy of web edge sensors that position the web in the cross track direction, web camber, or misalignment of rollers through the media operation zone. The change in web skew and front-to-back registration can cause significant delay in the setup of the printing system. In order to make corrections, operators of the printing system must manually evaluate web skew and front-to-back registration via eye-loop measurements of printed output. The operator must then manually change web servo set points to make the necessary corrections to web skew and front-to-back registration, which is often an iterative process.

### SUMMARY

According to one aspect, a printing system can include lineheads that each jet ink onto a print media, rollers and other components that support a print media while the print media is transported through the printing system, and imaging devices positioned to capture images of both sides of the print media. A method for correcting for web skew and front-to-back registration includes capturing one or more images of test marks printed or formed on one side of the print media. One or more skew positional errors can be determined for each color plane using the one or more images of the test marks. One or more skew positional correction values can be determined based on at least one skew positional error. An operation or setting of a printing system component is adjusted based on at least one skew positional correction value. By way of example only, a set point of a servo-motor associated with a roller in the printing system can be adjusted based on at least one skew positional correction value.

According to another aspect, the test marks can be printed on the print media, where at least one test mark is printed for each color plane.

According to another aspect, one or more images of the test marks printed on the other side of the print media can be captured and one or more registration positional errors can be determined using images of the test marks printed on both sides of the print media. One or more registration positional correction values can be determined based on the registration positional error or errors. An operation or setting of a printing system component is adjusted based on at least one registration positional correction value. By way of example only, a set point of a servo-motor associated with a roller in the printing system can be adjusted based on at least one positional correction value.

### BRIEF DESCRIPTION OF THE DRAWINGS

Embodiments of the invention are better understood with reference to the following drawings. The elements of the drawings are not necessarily to scale relative to each other. Like numbers indicate like parts throughout the views,

FIG. 1 illustrates a top view of a desired positional relationship between a web and the lineheads in a printing system;

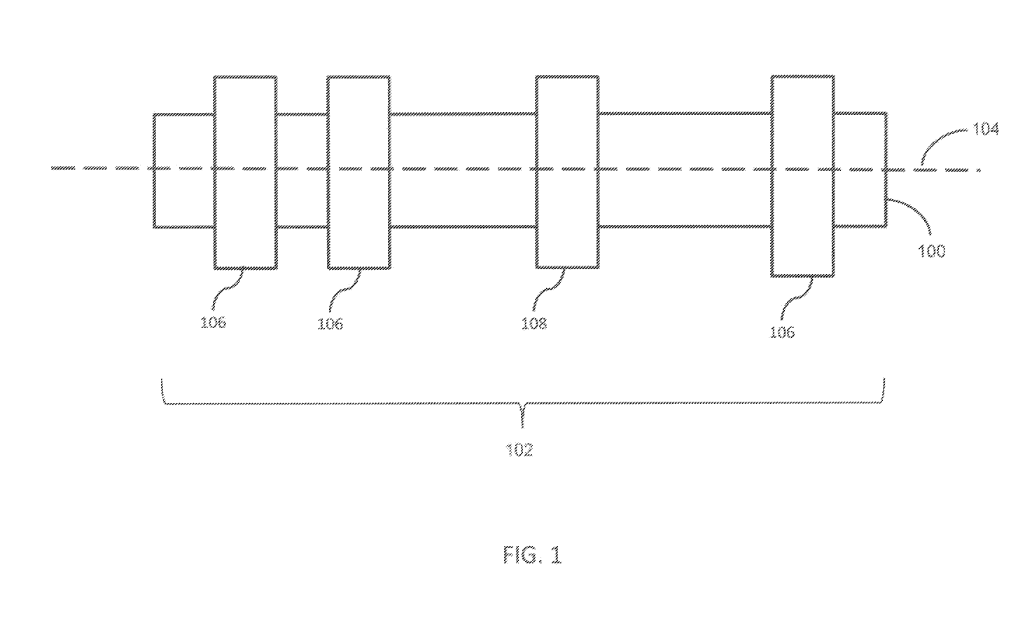

FIG. 2 depicts a top view of a web skew in a printing system;

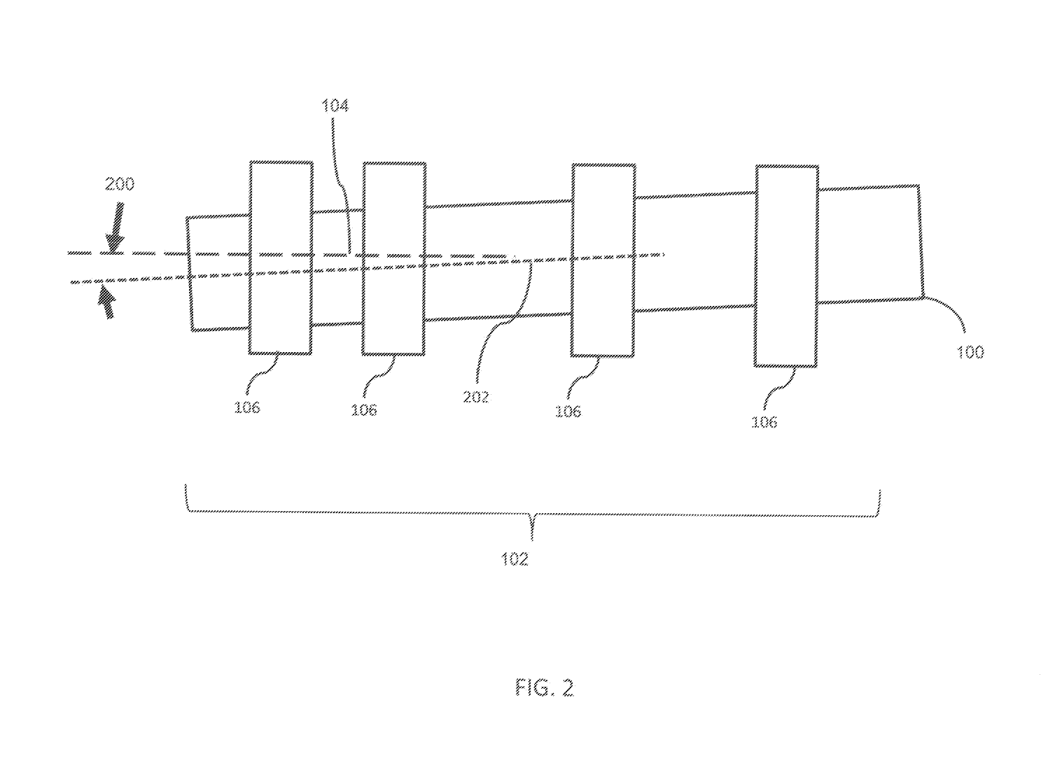

FIG. 3 illustrates a top view of front-to-back misalignment in the cross-track direction in a printing system;

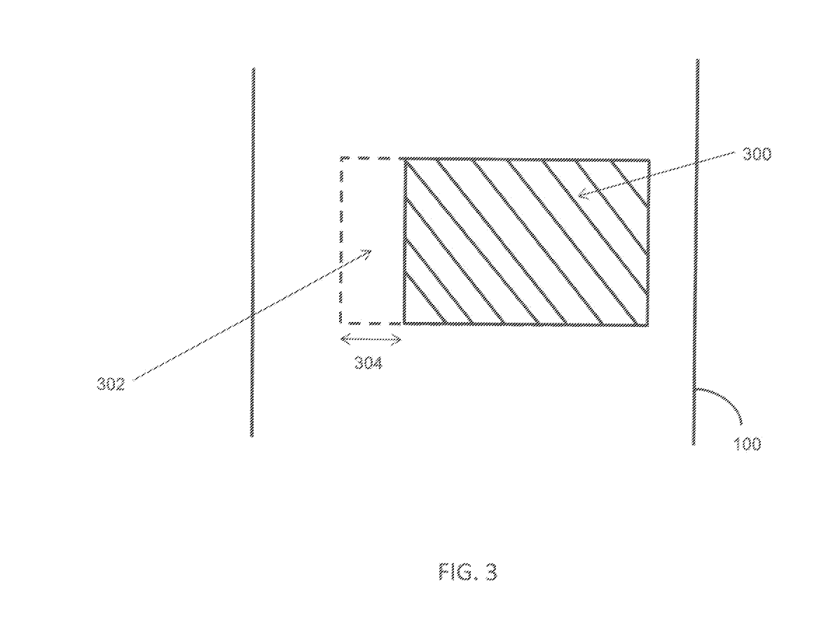

FIG. 4 is a schematic side view of one example of a continuous web printing system;

FIG. 5 is a partial schematic top view of a printing module in an embodiment in accordance with the invention;

FIG. 6 illustrates a side view of some of the media transport components in an embodiment in accordance with the invention;

FIG. 7 is a perspective view of some of the media transport components shown in FIG. 6 in an embodiment in accordance with the invention;

FIG. 8 depicts a top view

FIGS. 8A-8B is a flowchart of a method for correcting web skew and front-to-back registration in a printing system in an embodiment in accordance with the invention; and

FIG. 9 depicts an example of content and test marks on a print media in an embodiment in accordance with the invention.

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.” Additionally, directional terms such as “on”, “over”, “top”, “bottom”, “left”, “right” are used with reference to the orientation of the Figure(s) being described. Because components of embodiments of the present invention can be positioned in a number of different orientations, the directional terminology is used for purposes of illustration only and is in no way limiting.

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate like elements. It is to be understood that elements and components can be referred to in singular or plural form, as appropriate, without limiting the scope of the invention.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention apply to correcting web skew and front-to-back registration as a web is transported through a printing system. The web can be the print media or a support mechanism that is routed through the printing system. Inkjet printing is commonly used for printing on paper, where paper is the print media. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

Many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by a nozzle, a printhead, or by printhead components described below.

Inkjet printing is a non-contact application of an ink to a print media. Typically, one of two types of ink jetting mechanisms are used and are categorized by technology as either drop on demand ink jet (DOD) or continuous ink jet (CIJ). The first technology, “drop-on-demand” (DOD) ink jet printing, provides ink drops that impact upon a recording surface using a pressurization actuator, for example, a thermal, piezoelectric, or electrostatic actuator. One commonly practiced drop-on-demand technology uses thermal actuation to eject ink drops from a nozzle. A heater, located at or near the nozzle, heats the ink sufficiently to boil, forming a vapor bubble that creates enough internal pressure to eject an ink drop. This form of inkjet is commonly termed “thermal ink jet (TIJ).”

The second technology commonly referred to as “continuous” ink jet (CIJ) printing, uses a pressurized ink source to produce a continuous liquid jet stream of ink by forcing ink, under pressure, through a nozzle. The stream of ink is perturbed using a drop forming mechanism such that the liquid jet breaks up into drops of ink in a predictable manner. One continuous printing technology uses thermal stimulation of the liquid jet with a heater to form drops that eventually become print drops and non-print drops. Printing occurs by selectively deflecting one of the print drops and the non-print drops and catching the non-print drops. Various approaches for selectively deflecting drops have been developed including electrostatic deflection, air deflection, and thermal deflection.

Additionally, there are typically two types of web used with inkjet printing systems. The first type is commonly referred to as a continuous web while the second type is commonly referred to as a cut sheet(s). The continuous web refers to a continuous strip of print media, generally originating from a source roll. The continuous web is moved relative to the inkjet printing system components via a web transport system, which typically include drive rollers, web guide rollers, and web tension sensors. Cut sheets refer to individual sheets of print media that are moved relative to the inkjet printing system components via a support mechanism (e.g., rollers and drive wheels or via a conveyor belt system) that is routed through the inkjet printing system.

The invention described herein is applicable to both types of printing technologies. As such, the terms linehead and printhead, as used herein, are intended to be generic and not specific to either technology. Additionally, the terms linehead, printhead, print media, and web can be applied to other nontraditional inkjet applications, such as printing conductors on plastic sheets or medicines or materials on skin.

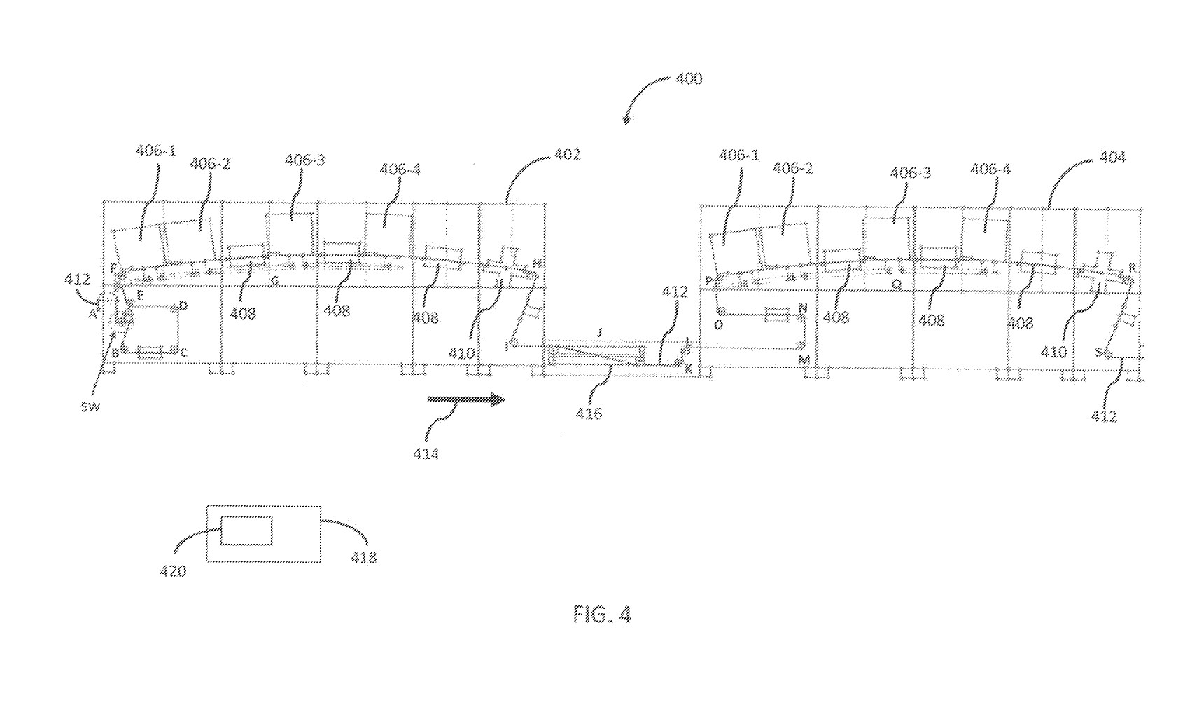

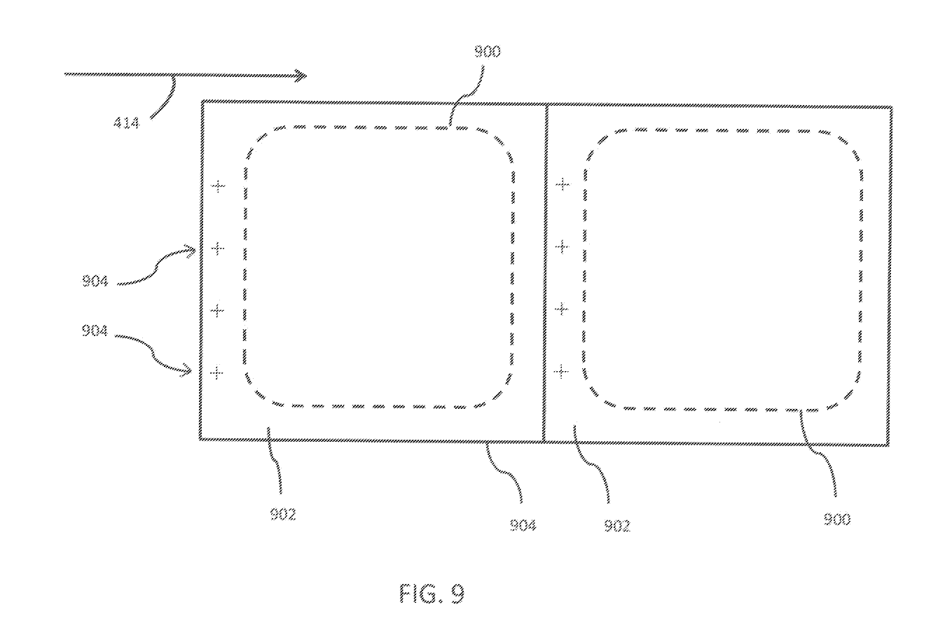

The terms “upstream” and “downstream” are terms of art referring to relative positions along the transport path of the web; points on the transport path move from upstream to downstream. In FIGS. 4 and 9 the print media moves from left to right as indicated by feed direction arrow 414. Where they are used, terms such as “first”, “second”, and so on, do not necessarily denote any ordinal or priority relation, but are simply used to more clearly distinguish one element from another.

Referring now to the schematic side view of FIG. 4, there is shown one example of a continuous web printing system. Printing system 400 includes a first printing module 402 and a second printing module 404, each of which includes lineheads 406, dryers 408, and a quality control sensor 410. Each linehead 406 typically includes multiple printheads (not shown) that apply ink or another liquid to the surface of the continuous web of print media 412 that is adjacent to the printheads. For descriptive purposes only, the lineheads 406 are labeled a first linehead 406-1, a second linehead 406-2, a third linehead 406-3, and a fourth linehead 406-4. In the illustrated embodiment, each linehead 406-1, 406-2, 406-3, 406-4 applies a different colored ink to the surface of the print media 412 that is adjacent to the lineheads. By way of example only, linehead 406-1 applies cyan colored ink, linehead 406-2 magenta colored ink, linehead 406-3 yellow colored ink, and linehead 406-4 black colored ink.

The first printing module 402 and the second printing module 404 also include a web tension system that serves to physically move the print media 412 through the printing system 400 in the feed direction 414 (left to right as shown in the figure). The print media 412 enters the first printing module 402 from a source roll (not shown) and the linehead(s) 406 of the first module applies ink to one side of the print media 412. As the print media 412 feeds into the second printing module 404, a turnover module 416 is adapted to invert or turn over the print media 412 so that the linehead(s) 406 of the second printing module 404 can apply ink to the other side of the print media 412. The print media 412 then exits the second printing module 404 and is collected by a print media receiving unit (not shown).

First printing module 402 has a support structure that includes a cross-track positioning mechanism (A) for positioning the continuously moving web of print media in the cross-track direction, that is, orthogonal to the direction of travel and in the plane of travel. In one embodiment, cross-track positioning mechanism (A) is an edge guide for registering an edge of the moving media. An S-wrap device (SW), affixed to the support structure of first module 402, includes structure that sets the tension of the print media.

Downstream from the first printing module 402 along the path of the print media 412, the second printing module 404 also has a support structure similar to the support structure for first printing module 402. Affixed to the support structure of either or both the first or second module is a kinematic connection mechanism that maintains the kinematic dynamics of the print media 412 in traveling from the first printing module 402 into the second printing module 404. Also affixed to the support structure of either the first or second module are one or more angular constraint structures for setting an angular trajectory of the print media 412.

Table 1 that follows identifies the lettered components used for print media transport as shown in FIG. 4. In the illustrated embodiment, an edge guide in which the print media 412 is pushed laterally so that an edge of the media contacts a stop is provided at (A). The slack print media entering the edge guide allows the print media 412 to be shifted laterally without interference and without being over-constrained. The S-wrap device (SW) provides stationary curved surfaces over which the continuous print media 412 slides during transport. As the print media 412 is pulled over these surfaces, the friction of the print media 412 across these surfaces produces tension in the print media. In one embodiment, the S-wrap device (SW) is adapted to adjust the positional relationship between surfaces, to control the angle of wrap and to allow adjustments in the tension of the print media.

TABLE 1
Roller Listing for FIG. 4

| Media | |
|---|---|
| Handling | |
| Component | Type of Component |
| A | Lateral Constraint (edge guide) |
| SW | S-wrap device |
| B | In-Feed Drive Roller |
| C | Castered and Gimbaled Roller |
| D | Gimbaled Load Cell |
| E | Servo-Castered and Gimbaled Roller |
| F | Fixed Roller (tach) |
| G | Rainbow Rollers (Qty = 17, 8 linehead, 6 dryer, 3 QC) |
| H | Servo-Castered and Gimbaled Roller |
| I | Gimbaled Roller |
| J | First Turnover Mechanism Drive |
| J | Second Turnover Mechanism Drive |
| K | Castered and Gimbaled Roller |
| L | Gimbaled Roller |
| M | Castered and Gimbaled Roller |
| N | Gimbaled Load Cell |
| O | Servo-Castered and Gimbaled Roller |
| P | Fixed Roller (tach) |
| Q | Rainbow Rollers (Qty = 17, 8 linehead, 6 dryer, 3 QC) |
| R | Servo-Castered and Gimbaled Roller |
| S | Out-Feed Drive Roller |

The first angular constraint is provided by in-feed drive roller B. This is a fixed roller that cooperates with a drive roller in the turnover module 416 and with an out-feed drive roller N in second printing module 404 in order to move the print media 412 through the printing system 400 with suitable tension in the feed direction 414. The tension provided by the preceding S-wrap device (SW) serves to hold the print media 412 against the in-feed drive roll. Angular constraints at subsequent locations downstream along the print media 412 are provided by rollers that are gimbaled so as not to impose an angular constraint on the next downstream media span.

Processing device 418 can be connected to various components in the web tension system and used to control the positions of the components, such as gimbaled or caster rollers. Processing device 418 can be connected to the quality control sensor 410 and used to process images or data received from the sensor 410. Processing device can be connected to components in printing system 400 using any known wired or wireless communication connection. Processing device 418 can be a separate from printing system 400 or integrated within printing system 400 or within a component in printing system 400.

A storage device 420 is connected to the processing device 418. The storage device 420 can store skew or registration positional correction values in an embodiment in accordance with the invention. The storage device 420 can be implemented as a memory device and as a one or more external storage devices; one or more storage devices included within the image processing device 418; or a combination thereof.

Although FIG. 4 depicts each printing module with four lineheads 406, three dryers 408, and one quality control sensor 410, embodiments in accordance with the invention are not limited to this construction. A printing system can include any number of lineheads, any number of dryers, and any number of quality control sensors. The printing system can also include a number of other components, including, but not limited to, web cleaners and web tension sensors.

And although the printing system shown in FIG. 4 has the turnover module 416 disposed between the first and second printing modules 402, 404, other printing systems can include the turnover module within one of the printing modules.

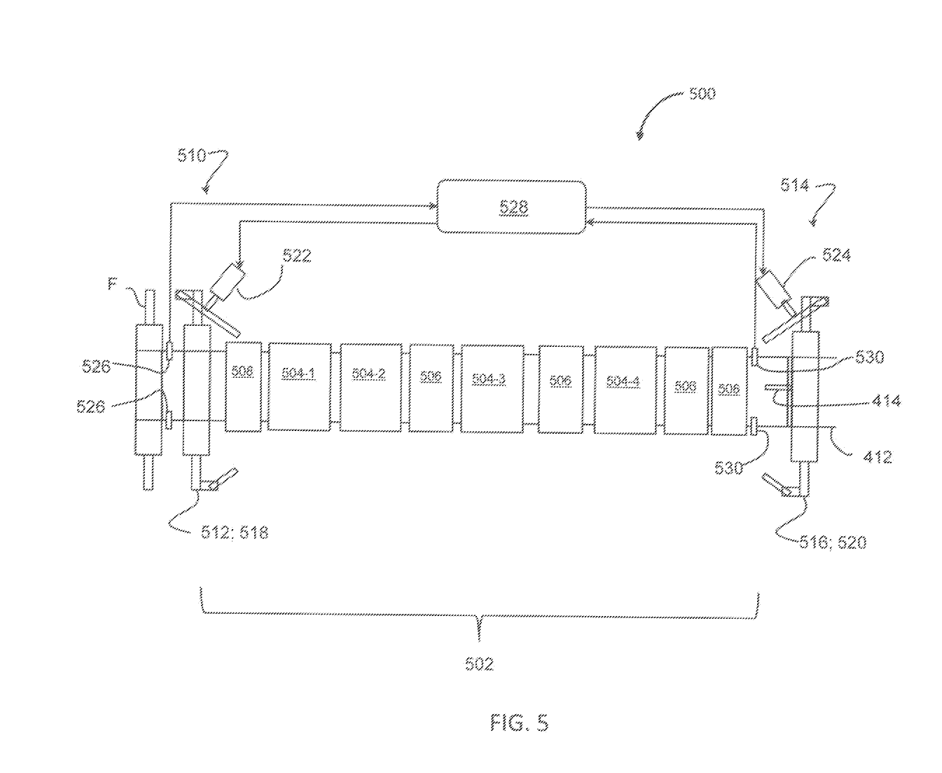

FIG. 5 is a partial schematic top view of a printing module in an embodiment in accordance with the invention. Printing module 500 can be implemented as a single printing module or included in a multi-module printing system. Printing module 500 includes a media operation zone 502 in which an operation is performed on a print media 412. In the illustrated embodiment, the lineheads 504 jet ink onto the print media, the dryers 506 dry the ink, and the imaging devices 508 capture one or more images of the print media. In one embodiment in accordance with the invention, the imaging devices 508 are used to capture images of test marks printed or formed on the print media 412.

A web transport system guides the continuous web of print media 412 under tension through the media operation zone 502. A first mechanism 510 located upstream relative to the media operation zone 502 includes structure 512 that positions the print media 412 in a cross track direction so as to establish center justification of the print media 412 as the print media 412 enters the media operation zone 502. A second mechanism 514, located downstream relative to the media operation zone 502, includes structure 516 that positions the print media 412 in a cross track direction so as to maintain center justification of the print media 412 within the media operation zone 502. In this sense, the center line of the print media web is maintained within acceptable tolerances by controlling the cross track position or location of the web of print media. Typically, the center line of the print media is maintained within acceptable tolerances relative to a device that is performing an operation on the print media while the print media is traveling through (located in) the media operation zone 502.

As discussed earlier, the lineheads 504-1, 504-2, 504-3, 504-4 jet ink onto the print media 412 in response to supplied print data in the span between roller 511 and roller 520, which includes the media operation zone 502. Water-based inks add moisture to the print media 412, which can cause the print media to expand, especially in the cross-track direction. The added moisture also lowers the stiffness of the print media 412. The dryers 506 that follow the lineheads 504-2, 504-3, 504-4 dry the ink, typically by directing heat and a flow of air at the print media 412. Each dryer 506 drives moisture out of the print media 412, causing the print media to shrink and its stiffness to change. The changes to the print media 412 in the media operation zone 502 can cause the print media 412 to drift in the cross-track direction as the print media passes through the media operation zone 502. The width of the print media 412 as the print media exits the media operation zone 502 can differ from the width of the print media 412 that entered the media operation zone 502.

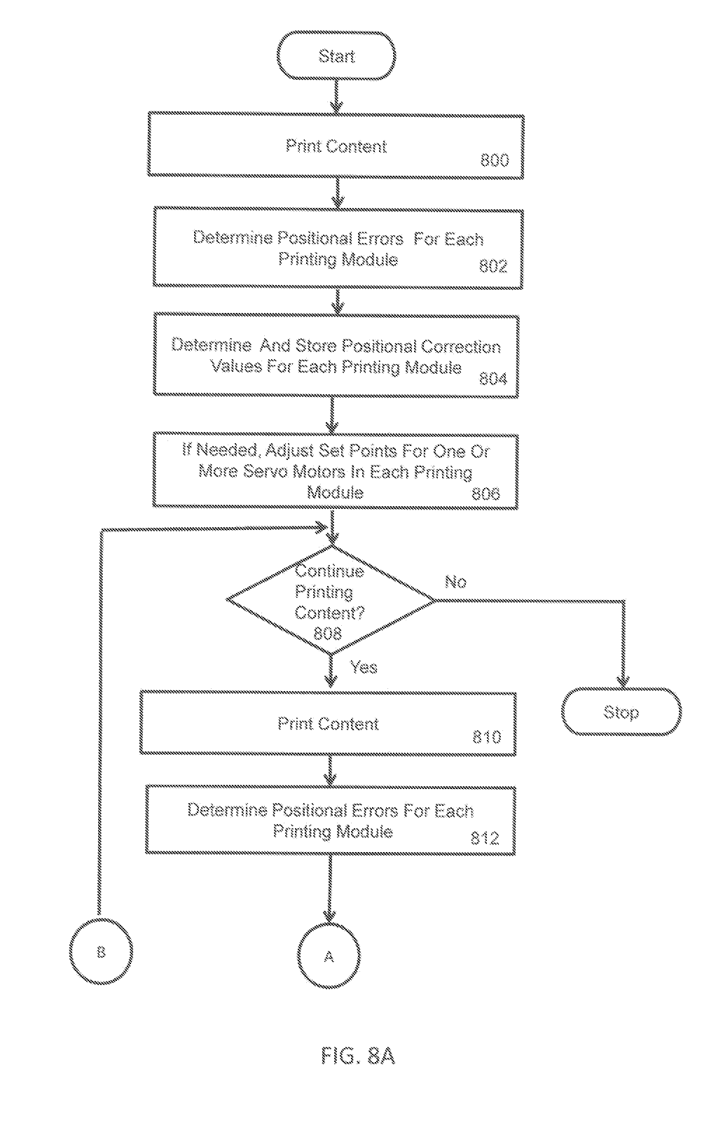

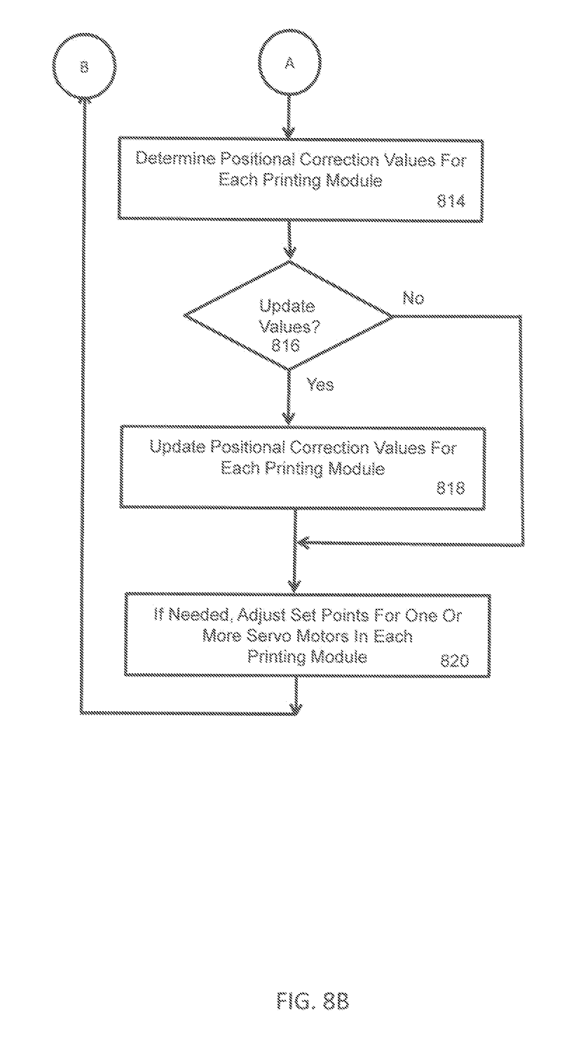

To accommodate these effects, structure 512 of first mechanism 510 and structure 516 of second mechanism 514 each include a steered angular constraint with hinge, such as a servo-caster with gimbaled roller 518, 520 that is rotatable about a caster roller axis. Steering of each servo-caster with gimbaled roller 518, 520 is accomplished by adjustment of an angle of the caster roller about the caster axis using, for example, a servo motor 522, 524 shown in more detail in FIG. 8.

In the first printing module 402 shown in FIG. 4, rollers 511 and 520 are rollers F and H, respectively. Roller 518 is roller E that is used to center justify the print media 412 as the print media enters the media operation zone 502, and roller H is used to center justify the print media 412 as it leaves the media operation zone 502. In the second printing module 404 of FIG. 4, rollers 511 and 520 are rollers P and R, respectively. Roller 518 is roller O that is used to center justify the print media 412 as the print media enters the media operation zone 502, and roller R is used to center justify the print media 412 as it leaves the media operation zone 502.

The configuration of the caster rollers 518, 520 is conventional. The servo motor 522, 524 is also conventional and commercially available, for example, from Ultra Motion, located in Cutchogue, N.Y. Alternatively, any conventional servo motor can be used provided it has the performance characteristics to make it suitable for the type of roller steering contemplated herein.

First mechanism 510 additionally includes sensors 526 that sense the cross track position of the print media 412 and communicate with a control system 528 that controls the first structure 512 to position the print media 412 in a cross track direction based on information received from sensors 526. Sensors 526 are located between structure 512 of first mechanism 510 and media operation zone 502 to provide an accurate measurement of the print media as it enters the media operation zone.

Second mechanism 514 additionally includes sensors 530 that sense the cross track position of the print media 412 and communicate with control system 528 to control structure 516 to actively position the print media 412 in a cross track direction based on information received from sensors 530. Sensors 530 are located between the structure 516 of second mechanism 514 and media operation zone 502.

The sensors 526, 530 include sensing elements positioned on both the first and the second edge of the print media in an embodiment in accordance with the invention. By means of the sensing elements along both sides (edges) of the print media, each sensor 526, 530 can determine the width of the print media 412 and the cross-track position of the centerline of the print media. In one or more embodiments in accordance with the invention, the determination of the width of the print media and the cross track position of the centerline of the print media is carried out within each sensor 526 and 530, which sends that information to the control system 528. In other embodiments, each sensor 526, 530 sends the position of the first edge and the position of the second edge of the print media to the control system 528, which uses that data to determine of the width of the print media and the cross track position of the centerline of the print media.

The control system 528 can be included in the same control system or in multiple control systems. The one or more control systems can be on-board control systems or external control systems. Alternatively, the control system 528 can be incorporated into processing device 418 (see FIG. 4).

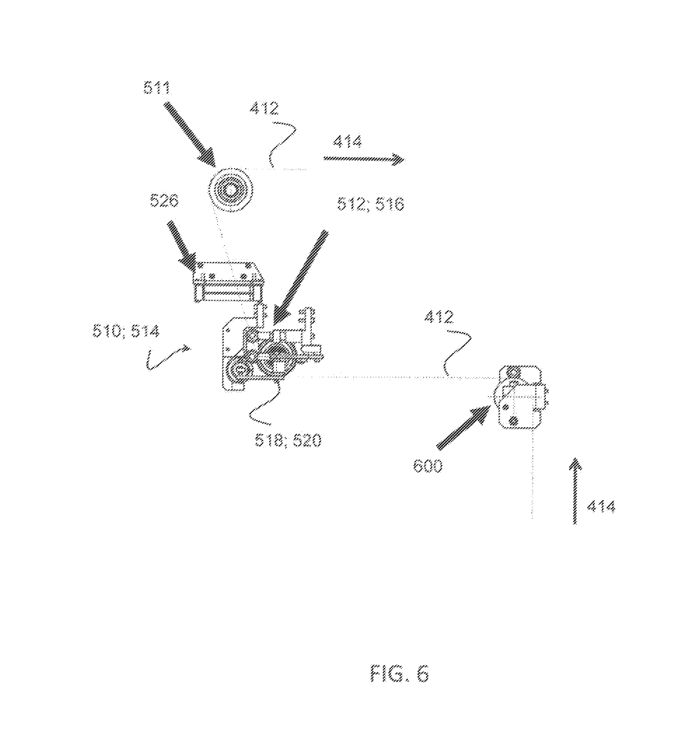

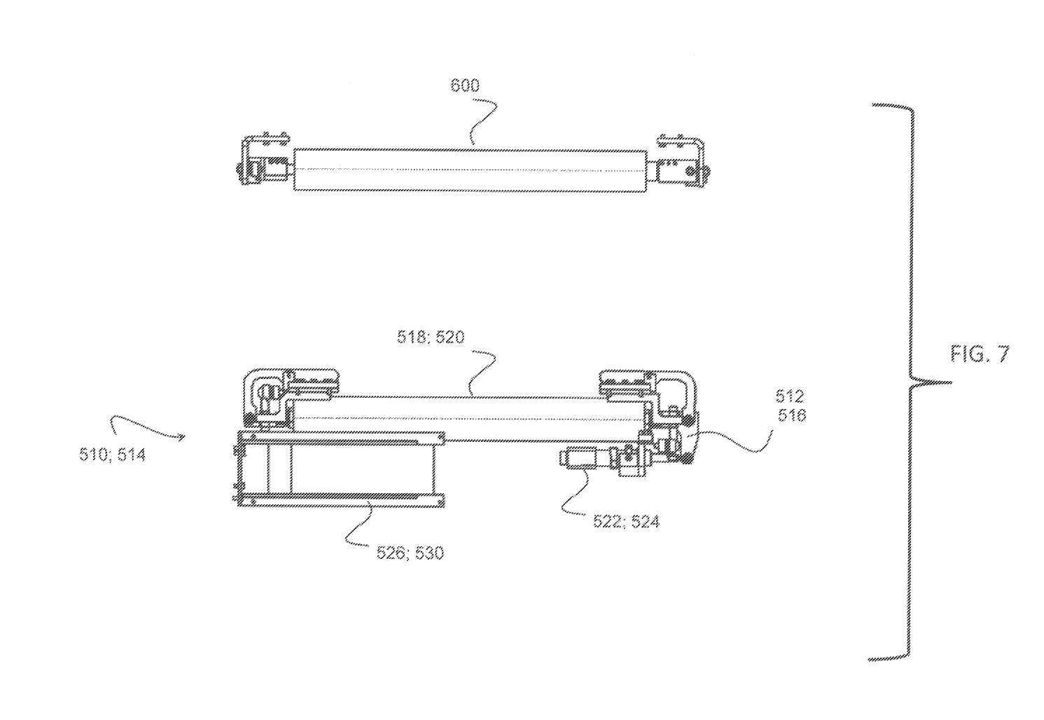

The servo-caster with gimbaled roller will now be described in more detail with reference to FIGS. 6 and 7. FIG. 6 is a side view of some of the media transport components in an embodiment in accordance with the invention. First mechanism 510 includes structure 512, servo motor 522, and sensor 526. By way of example only, in the FIG. 4 embodiment, structure 512 is located in roller locations E, O, or both E and O. Also shown in FIGS. 6 and 7 is a fixed roller 600 positioned at a location for roller F or P (see FIG. 4) and a gimbal roller 602 positioned at a location for roller D or N.

Sensor 526 senses the cross track position of the print media 412 and sends this information to control system 528. Depending on the information received by control system 528, control system 528 steers caster roller 518 using servo motor 522 to adjust a location of caster roller 518 through linkage connected to an arm that is responsive to servo motor 522 to adjust the position the print media 412 in a cross track direction. Sensor 526 can be a conventional print media edge sensor.

Second mechanism 514 is configured in the same manner as that of first mechanism 510 shown in FIGS. 6-7 in an embodiment in accordance with the invention.

To correct for web skew and front-to-back misalignment, a printing system can include multiple imaging devices 508, such as cameras, sensors, or scanners, in each printing module. For example, in the printing system depicted in FIG. 4, two imaging devices, such as two image quality sensors 410, can be included in first printing module 402 and four imaging devices in the second printing module 404. One of the two imaging devices in the first printing module 402 can be positioned to image the print media, or a portion of the print media, as the print media enters the media operation zone. The other imaging device in the first printing module 402 can be positioned to image the print media, or a portion of the print media, as the print media exits the media operation zone. These two imaging devices can be used to correct web skew in the first printing module 402.

Three of the four imaging devices in the second printing module 404 can image the top side of the print media (the side of the print media receiving jetted ink from the lineheads) and one imaging device can image the bottom side of the print media. One of the three imaging devices that image the top side and the one imaging device that images the bottom side can be used to correct front-to-back misalignment and can be located near the exit of the media operation zone. The other two imaging devices that image the top side of the print media in the second printing module 404 can be used to correct web skew in the second printing module.

Referring now to FIGS. 8A-8B, there is shown a flowchart of a method for correcting web skew and front-to-back registration in a printing system in an embodiment in accordance with the invention. Initially, content is printed on the print media, as shown in block 800. Embodiments in accordance with the invention can be used to correct for web skew and front-to-back registration when calibrating a printing system prior to performing a print job or while content is being printed on the print media during a print job. As such, the content can be test content used when calibrating the printing system or content from a print job.

Typically, each linehead in a commercial printing system jets only one color. Thus, there is a linehead for each colored ink when different colored inks are used to print content. For example, the four lineheads in printing system 400 shown in FIG. 4 can print with cyan, magenta, yellow and black colored inks. The content is printed by jetting the colored inks sequentially, and each colored ink deposited on the print media is known as a color plane. The color planes need to be aligned, or registered with each other so that the overlapping ink colors produce a quality single image.

The skew positional errors for each color plane and/or the registration positional errors are then determined at block 802. By way of example only, in the FIG. 4 embodiment skew positional errors for printing module 402 can be determined or skew and registration errors for printing module 404 can be determined. The skew or registration positional errors can be determined by comparing one or more test marks printed or formed on the print media as the print media moves through the printing system. Typically, at least one test mark is printed for each color of ink.

FIG. 9 depicts an example of content and test marks on a print media in an embodiment in accordance with the invention. The content area 900 is an area on the print media where published information such as text, images, animation, and graphics will be printed on the print media. The content area 900 is surrounded by a margin 902 of print media where published information is not printed. Test marks 904 can be printed, pre-printed, or formed on the print media in the margin 902 in an embodiment in accordance with the invention. In the illustrated embodiment, one set of test marks 904 is formed along the top section of the margin (relative to the content area and the transport direction 414). Other embodiments can position the test marks at any given position in one or more margins 902 or in the content area 900.

Images of the test marks as the print media is moving through the printing system are captured by the imaging devices (e.g., 508 in FIG. 5) to determine skew positional errors. For web skew, the locations of the test marks in each set of test marks can be compared to a reference test mark in each set of test marks. For example, in a cyan magenta yellow, and black (CMYK) printing system, the black test mark can be used as a reference test mark, and the position of the cyan test mark is compared to the position of the black test mark, the position of the magenta test mark is compared to the position of the black test mark, and the position of the yellow test mark is compared to the location of the black test mark.

For front-to-back registration, a respective image capture device captures images of the top side of the print media while the other image capture device captures images of the bottom side of the print media. In one embodiment in accordance with the invention, the image capture devices capture images of one color test mark, such as the black test marks. The location of the black test mark on the top side of the print media is compared to the location of the black test mark on the bottom side of the print media to determine the registration positional errors.

Next, as shown in block 804, skew and/or registration positional correction values are determined. The skew or registration positional correction values can be any value, including zero. The skew or registration positional correction values can be stored in memory. For example, the skew or registration positional correction values can be stored in a look-up table in storage device 420 in FIG. 4.

The set points for the servo motors in one or both printing modules can then adjusted, if needed, based on the skew or registration positional correction values (block 806). A determination is made at block 808 as to whether or not the printing of content on the print media is to continue. If printing is to continue, the process passes to block 810 where the content is printed.

The skew and/or registration positional error in each printing module is then determined. Next, as shown in block 814, skew and/or registration positional correction values are determined for each printing module. Again, the positional skew or registration correction values can be any value, including zero. The skew or registration positional correction values can be stored in memory.

A determination is then made at block 816 as to whether or not the skew or registration positional correction values are to be updated. If the values are to be updated, the method continues at block 818 where one or more positional correction values are updated for each printing module. The skew or registration positional correction values can be updated periodically, non-periodically, or every time using different known techniques. For example, a running average of each skew or registration positional correction value can be determined. Alternatively, a rolling window of skew or registration positional correction values can be determined. The rolling window can include N number of correction values. For example, the last five correction values can be used to update the positional correction values. Alternatively, the skew or registration positional correction values can be determined during a certain time period and used to update the respective positional correction values.

Next, as shown in block 820, the set points for one or more servo motors in each printing module can then adjusted, if needed, based on the skew or registration positional correction values. The process then returns to block 808 and repeats until the print job is completed.

The invention has been described in detail with particular reference to certain preferred embodiments thereof, but it will be understood that variations and modifications can be effected within the spirit and scope of the invention. For example, the method depicted in FIG. 8 adjusts the set points for one or more servo motors in each printing module based on the skew or registration positional correction values. Other embodiments in accordance with the invention can adjust the setting or operation of different printing system components. By way of example only, the setting or operation of one or more nip rollers can be adjusted, or the mechanism that tacks the cut sheets to the conveyor belt can be adjusted. Alternatively, a combination of printing system components can be adjusted to correct for web skew or front-to-back misregistration.

And even though specific embodiments of the invention have been described herein, it should be noted that the application is not limited to these embodiments. In particular, any features described with respect to one embodiment may also be used in other embodiments, where compatible. The features of the different embodiments may be exchanged, where compatible.

1. A printing system can include one or more printing modules, with each printing module including lineheads and imaging devices. The imaging devices are positioned to capture images of one or both sides of the print media. Rollers can support the print media as the print media is transported through the printing system. The lineheads jet ink onto a print media as the print media is transported through the printing system. A method for correcting for skew and front-to-back registration in the printing system includes capturing one or more images of test marks printed or formed on one side of the print media and determining one or more skew positional errors for each color plane in a printing module using at least one captured image. One or more skew positional correction values is determined based on at least one skew positional error. A setting or operation of at least one printing system component is adjusted based on at least one skew positional correction value.

2. The method as in clause 1, where a set point of a servo-motor associated with at least one roller in the printing system is adjusted based on at least one skew positional correction value.

3. The method in clause 1 or clause 2 can include printing test marks on the print media, where at least one test mark is printed for each color plane.

4. The method in any one of clauses 1-3 can include averaging the skew positional correction values determined for a respective color plane.

5. The method in any one of clauses 1-4 can include storing the one or more skew positional correction values.

6. The method in any one of clauses 1-5 can include capturing one or more images of the test marks printed or formed on the other side of the print media and determining one or more registration positional errors using captured images of the test marks printed on both sides of the print media. One or more registration positional correction values can be determined based on at least one registration positional error. A setting or operation of at least one printing system component is adjusted based on at least one registration positional correction value.

7. The method as in clause 6, where a set point of a servo-motor associated with at least one roller in the printing system can be adjusted based on the one or more registration positional correction values.

8. The method in clause 6 or clause 7 can include storing the one or more registration positional correction values.

9. The method in any one of clauses 6-8 can include averaging the registration positional correction values.

10. The method as in any one of clauses 1-9, where determining a skew positional error for each color plane in a printing module can include comparing a location of each test mark to a reference test mark.

### PARTS LIST

100 print media
102 media operation zone
104 center line
106 linehead
108 dryer
200 amount of skew
202 center line
300 front-side image
302 back-side image
304 amount of shift
400 printing system
402 printing module
404 printing module
406 linehead
408 dryer
410 quality control sensor
412 print media
414 feed direction
416 turnover module
418 processing device
420 storage device
500 printing module
502 media operation zone
504 linehead
506 dryer
508 imaging device
510 first mechanism
511 roller
512 structure
514 second mechanism
516 structure
518 servo-caster with gimbaled roller
520 servo-caster with gimbaled roller
522 servo motor
524 servo motor
526 sensor
528 controller
530 sensor
600 roller
900 content area
902 margin
904 test marks
A, B, C, D, E, F, G, H, 1, J, K, L, M, N, O, P, Q, R, S Rollers
SW S-wrap

1. A method for correcting for skew and front-to-back registration in a printing system, wherein the printing system includes at least one printing module comprising a plurality of lineheads, a plurality of imaging devices, and printing system components that guide a print media as the print media is transported through the at least one printing module, the method comprising:
capturing one or more images of test marks printed or formed on one side of the print media;
determining at least one skew positional error for each color plane in a printing module using at least one captured image;
determining one or more skew positional correction values based on at least one skew positional error; and
automatically adjusting a setting or operation of at least one printing system component based on at least one skew positional correction value.

2. The method as in claim 1, wherein automatically adjusting a setting or operation of at least one printing system component based on at least one skew positional correction value comprises automatically adjusting a set point of a servo-motor associated with at least one roller in the printing system based on at least one skew positional correction value.

3. The method as in claim 1, further comprising printing test marks on the one side of the print media, wherein at least one test mark is printed for each color plane.

4. The method as in claim 1, further comprising averaging the skew positional correction values determined for a respective color plane.

5. The method as in claim 1, further comprising storing the one or more skew positional correction values.

6. The method as in claim 1, further comprising:
capturing one or more images of test marks printed or formed on the other side of the print media;
determining one or more registration positional errors using captured images of the test marks printed on both sides of the print media;
determining one or more registration positional correction values based on at least one registration positional error; and
automatically adjusting a setting or operation of at least one printing system component based on at least one registration positional correction value.

7. The method as in claim 6, wherein automatically adjusting a setting or operation of at least one printing system component based on at least one registration positional correction value comprises automatically adjusting a set point of a servo-motor associated with at least one roller in the printing system based on at least one registration positional correction value.

8. The method as in claim 6, further comprising printing test marks on the other side of the print media, wherein at least one test mark is printed for one or more color planes.

9. The method as in claim 6, further comprising storing the one or more registration positional correction values.

10. The method as in claim 1, wherein determining a skew positional error for each color plane in a printing module comprises comparing a location of each test mark to a reference test mark.
